(19) United States
(12) Patent Application Publication
(10) Pub. No.: US 2010/0111398 A1
(43) Pub. Date: May 6, 2010

(54) METHOD AND SYSTEM FOR DETECTION OF ORAL SUB-MUCOUS FIBROSIS USING MICROSCOPIC IMAGE ANALYSIS OF ORAL BIOPSY SAMPLES

(75) Inventors: Biswadip Mitra, Bangalore (IN); Pratik Shah, Kheda (IN); Muthu Rama Krishnan Mookiah, Kadayanallur (IN); Ajoy Kumar Ray, Kharagpur (IN); Jyotirmoy Chatterjee, Kharagpur (IN); Chandan Chakraborty, Kharagpur (IN); Ranjan Rashimi Paul, Kolkata (IN); Mousumi Pal, Kolkata (IN)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/605,400

(22) Filed: Oct. 26, 2009

(30) Foreign Application Priority Data
Oct. 31, 2008 (IN) 2660/CHE/2008

(51) Int. Cl. G06K 9/00

(52) U.S. Cl. 382/133

(57) ABSTRACT

Method and system for analyzing an image of an oral sample. The method includes receiving the image of the oral sample. The method also includes converting the image to a gray-scale image. Further, the method includes de-noising the gray-scale image. Furthermore, the method includes enhancing epithelial region in the gray-scale image. Also, the method includes generating a binary image from the gray-scale image. The method further includes detecting boundary of the epithelial region in the binary image. Furthermore, the method includes extracting the boundary of the epithelial region. The method also includes extracting the basal cell nuclei in the epithelial region. Further, the method includes determining one or more parameters of the epithelial region and the basal cell nuclei to enable detection of the oral sample as one of pre-malignant and non-malignant.

### REFERENCE TO PRIORITY APPLICATION

This application claims priority from Indian Provisional Application Serial No. 2660/CHE/2008 filed on Oct. 31, 2008, entitled “Characterize the epithelium at tissue level and cellular level to categorize cancerous from normal oral mucosa”, which is incorporated herein by reference in its entirety.

### TECHNICAL FIELD

Embodiments of the disclosure relate to analyzing of an image of an oral sample.

### BACKGROUND

Oral cancer is a cancerous tissue growth in oral cavity. Oral Submucous Fibrosis (OSF) is a progressive pre-cancerous condition that indicates presence of pre-malignant epithelial cells in the oral cavity that leads to oral cancer. Often, early diagnosis of the OSF prevents the pre-malignant epithelial cells from developing into oral cancer.

Detection of the OSF is done through analysis of tissue samples collected from oral mucosa. The oral mucosa is mucous membrane epithelium of the oral cavity. Existing techniques to detect the OSF rely on biopsy and microscopic examination of the tissue samples by a pathologist. The detection of the OSF is dependent on expertise or intelligence of the pathologist analyzing the tissue samples.

### SUMMARY

An example of a method for analyzing an image of an oral sample includes receiving the image of the oral sample. The method also includes converting the image to a gray-scale image. Further, the method includes de-noising the gray-scale image. Furthermore, the method includes enhancing epithelial region in the gray-scale image. The method includes generating a binary image from the gray-scale image. Further, the method includes detecting boundary of the epithelial region in the binary image. Furthermore, the method includes extracting the boundary of the epithelial region. The method also includes extracting basal cell nuclei in the epithelial region. Further, the method includes determining one or more parameters of the epithelial region and the basal cell nuclei to enable detection of the oral sample as one of pre-malignant and non-malignant.

Another example of a method for analyzing an image of an oral sample by an image processing unit includes receiving the image of the oral sample. The method includes converting the image to a gray-scale image. The method also includes detecting at least one of thickness of the epithelial region, visual texture of the epithelial region, number of basal cell nuclei per unit length, size of the basal cell nuclei, and shape of the basal cell nuclei from the gray-scale image. Further, the method includes classifying the oral sample as one of pre-malignant and non-malignant based on the detection.

An example of an image processing unit (IPU) for analyzing an image of an oral sample includes an image and video acquisition module that electronically receives the image. The IPU also includes a digital signal processor that detects at least one of thickness of epithelial region, visual texture of the epithelial region, number of basal cell nuclei per unit length, size of the basal cell nuclei, and shape of the basal cell nuclei from the image to enable detection of the oral sample as one of pre-malignant and non-malignant.

### BRIEF DESCRIPTION OF THE VIEWS OF DRAWINGS

In the accompanying figures, similar reference numerals may refer to identical or functionally similar elements. These reference numerals are used in the detailed description to illustrate various embodiments and to explain various aspects and advantages of the disclosure.

FIG. 1 illustrates an environment, in accordance with one embodiment;

FIG. 2 illustrates block diagram of a system for analyzing an image of an oral sample, in accordance with one embodiment;

FIG. 3 is a flow diagram illustrating a method for analyzing an image of an oral sample, in accordance with one embodiment;

FIG. 4 is another flow diagram illustrating a method for analyzing an image of an oral sample, in accordance with one embodiment;

FIG. 5 illustrates images corresponding to each step in computing thickness of epithelial region, in accordance with one embodiment;

FIG. 6 illustrates images corresponding to each step in computing visual texture of epithelial region, in accordance with one embodiment;

FIG. 7 illustrates images corresponding to each step in extracting basal layer of epithelial region, in accordance with one embodiment; and

FIG. 8 illustrates images corresponding to each step in computing number of basal cell nuclei per unit length, in accordance with one embodiment.

### DETAILED DESCRIPTION OF THE EMBODIMENTS

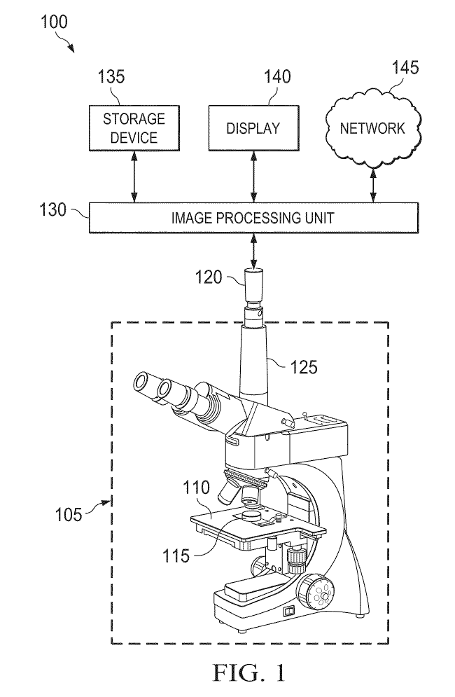

FIG. 1 is an environment 100 for analyzing an image of an oral sample. The oral sample includes oral mucosa. The oral mucosa is mucous membrane epithelium of oral cavity. Oral Submucous Fibrosis (OSF) is a progressive pre-cancerous condition that indicates presence of pre-malignant epithelial cells in the oral cavity that leads to oral cancer. Often, early diagnosis of the OSF prevents the pre-malignant epithelial cells from developing into oral cancer. The oral mucosa includes multiple layers, for example, the basal cell layer. The morphology of nuclei in the basal cell layer changes if affected with the OSF. The method and system used to analyze basal cell nuclei for detecting the oral sample as one of pre-malignant or non-malignant is explained in conjunction with FIG. 1 to FIG. 8.

Referring to FIG. 1 now, the environment 100 includes a microscope 105. The microscope 105, for example a trinocular microscope or a robotic microscope, includes a stage 110. A slide 115 is placed over the stage 110. The slide 115 includes the oral sample. The slide 115, for example can be a glass slide.

In some embodiments, the oral sample can be obtained using one or more techniques, for example incisional biopsy, punch biopsy, shave biopsy, excisional biopsy, or curettage biopsy. The incisional biopsy can be defined as a process of removing tissues using a blade, for example a scalpel blade or a curved razor blade. The incisional biopsy can include a lesion or part of affected skin and part of the normal skin. The oral sample obtained by incisional biopsy is then subjected to on one or more clinical procedures. The clinical procedure includes, but is not limited to paraffinization, de-paraffinization, treatment using alcohol, and treatment using xylene. The oral sample is also stained by treating the oral sample with Harris hematoxylin solution for few minutes, for example 8 minutes and with eosin-phloxine B solution or eosin Y solution for another few minutes, for example 1 minute. The staining can be referred to as haematoxylin & Eosin (H&E) staining and the oral sample obtained after staining can be referred to as H&E stained oral sample. After staining of the oral sample, color of nuclei when observed under the microscope 105 appears as blue and the color of cytoplasm when observed under the microscope 105 appears as pink or red.

The microscope 105 can be coupled to an image sensor, for example a digital camera 120. The coupling can be performed using an opto-mechanical coupler 125. The digital camera 120 acquires an image of the oral sample. The image of the oral sample can be acquired under 10×, 20×, 40×, 100× of primary magnification provided by the microscope 105. The magnification 10× is used for examination of epithelial region. The magnifications of 20× or 40× is used for examination of collagen fibre region. In some embodiments, both the magnifications of 20× and 40× are used for examination of the collagen fibre region. The magnification 100× is used for examination of basal cell nuclei. In one example, the digital camera 120 is capable of outputting the image having at least 1024×768 pixel resolution. In another embodiment, the digital camera 120 is capable of outputting the image having 1400×1328 pixel resolution.

The digital camera 120 can be coupled to an image processing unit (IPU) 130. The IPU can be a digital signal processor (DSP) based system. The digital camera 120 can be coupled to the IPU 130 through a network 145. In one example, the digital camera 120 is coupled to the IPU 130 via a direct link. Examples of direct link between camera and IPU 130 include, but are not limited to, BT656 and Y/C, universal serial bus port, and IEEE ports. The digital camera 120 can also be coupled to a computer which in turn is coupled to the network 145. Examples of the network 145 include, but are not limited to, internet, wired networks and wireless networks. The IPU 130 receives the image acquired by the digital camera 120 and processes the image.

In some embodiments, the IPU 130 can be embedded in the microscope 105 or in the digital camera 120. The IPU 130 processes the image to detect whether the oral sample is pre-malignant or non-malignant. The IPU 130 can be coupled to one or more devices for outputting result of processing. Examples of the devices include, but are not limited to, a storage device 135 and a display 140.

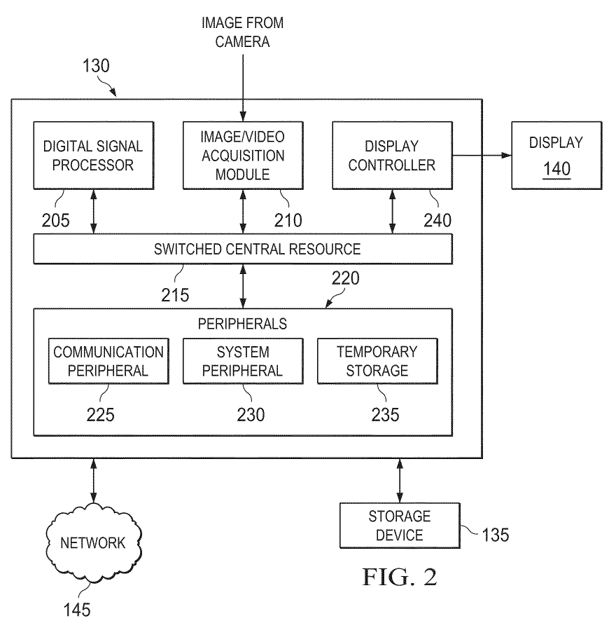

The IPU 130 can also be coupled to an input device, for example a keyboard, through which a user can provide an input. The IPU 130 includes one or more elements to analyze the image and is explained in conjunction with FIG. 2.

Referring to FIG. 2 now, the IPU 130 includes one or more peripherals 220, for example a communication peripheral 225, in electronic communication with other devices, for example a digital camera, the storage device 135, and the display 140. The IPU 130 can also be in electronic communication with the network 145 to send and receive data including images. The peripherals 220 can also be coupled to the IPU 130 through a switched central resource 215. The switched central resource 215 can be a group of wires or a hardwire used for switching data between the peripherals or between any component in the IPU 130. Examples of the communication peripheral 225 include ports and sockets. The IPU 130 can also be coupled to other devices for example at least one of the storage device 135 and the display 140 through the switched central resource 215. The peripherals 220 can also include a system peripheral 230 and a temporary storage 235. An example of the system peripheral 230 is a timer. An example of the temporary storage 235 is a random access memory.

An image and video acquisition module 210 electronically receives the image from an image sensor, for example the digital camera. In one example, the image and video acquisition module 210 can be a video processing subsystem (VPSS). The VPSS includes a front end module and a back end module. The front end module can include a video interface for receiving the image. The back end module can include a video encoder for encoding the image. The IPU 130 includes a digital signal processor (DSP) 205, coupled to the switched central resource 215, that receives the image of the oral sample and processes the image. The DSP 205 converts the image to a gray-scale image. Further, the DSP 205 determines one or more parameters of the epithelial region as well as parameters of the basal cell nuclei in the oral sample to enable detection of the oral sample as one of pre-malignant and non-malignant.

In some embodiments, the IPU 130 also includes a classifier that compares the parameters with a predefined set of values corresponding to a type of cancer. If the parameters match the predefined set of values then the classifier determines the oral sample to be pre-malignant else as non-malignant. The classifier also generates abnormality marked image, based on comparison, which can then be displayed, transmitted or stored, and observed.

In some embodiments, the DSP 205 also includes a classifier that compares the parameters with a predefined set of values corresponding to a type of cancer. If the parameters match the predefined set of values then the classifier determines the oral sample to be pre-malignant else as non-malignant. The classifier also generates abnormality marked image, based on comparison, which can then be displayed, transmitted or stored, and observed. The abnormalities marked image based on the plurality of parameters is displayed on the display 140 using a display controller 240.

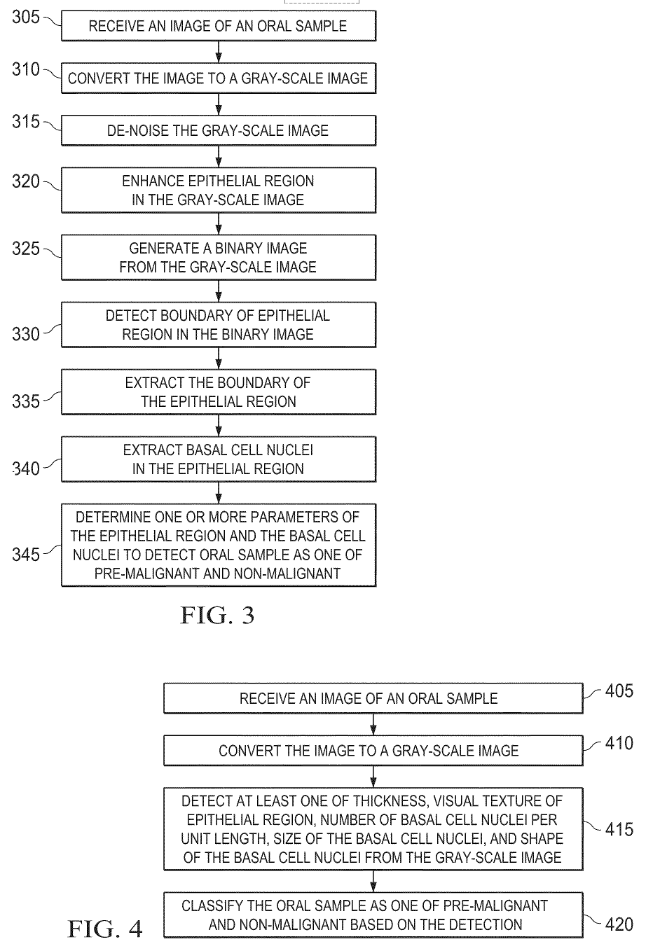

Referring to FIG. 3 now, a method for analyzing an image of a sample, for example an oral sample is illustrated. The oral sample can be obtained using incisional biopsy. The oral sample can be stained based on haematoxylin & eosin (H&E) staining. The analyzing can be performed using image processing unit (IPU). The IPU can be coupled to a source of the image. The source can be a digital camera or a storage device. The source, in turn, can be coupled to a microscope. The image can be captured when the oral sample is placed on a stage of the microscope by the digital camera.

At step 305, an image of an oral sample is received. The IPU receives the image from the source.

At step 310, the image is converted to a gray-scale image. The image can be a color image. The color image and the gray-scale image are made of picture elements, hereafter referred to as pixels.

At step 315, the gray-scale image is de-noised.

The gray-scale image can be processed using a weighted median filter to remove speckle noise and salt-pepper noise. The weighted median filter can be referred to as non-linear digital filtering technique and can be used to prevent edge blurring. A median of neighboring pixels values can be calculated. The median can be calculated by repeating following steps for each pixel in the image.
a) Storing the neighboring pixels in an array. The neighboring pixels can be selected based on shape, for example a box or a cross. The array can be referred to as a window, and is odd sized.
b) Sorting the window in numerical order.
c) Selecting the median from the window as the pixels value.

Various other techniques can also be used for removing noises. Examples of the techniques include, but are not limited to, a mean filter technique described in “Digital Image Processing” by R. C. Gonzalez and R. E. Woods, 2e, pp. 253-255, which is incorporated herein by reference in its entirety.

At step 320, epithelial region in the gray-scale image is enhanced using histogram stretching technique. The histogram stretching technique is an image enhancement technique that improves contrast in an image by modifying the range of gray-scale values the image contains. In some embodiments, the epithelial region can be enhanced based on histogram equalization. The histogram stretching technique is a linear scaling technique, whereas the histogram equalization is a non-linear scaling technique. The histogram stretching technique as described in a book titled “Digital Image Processing” by R. C. Gonzalez and R. E. Woods, 2e, pp. 107-108, is incorporated herein by reference in its entirety.

At step 325, a binary image from the gray-scale image is generated. The binary image can be defined as an image having two values for each pixel. For example, two colors used for the binary image can be black and white. Various techniques can be used for generating the binary image, for example Otsu auto-thresholding. The technique is described in a publication titled “A threshold selection method from gray-level histograms” by N Otsu published in IEEE Trans. Systems Man Cyber., vol. 9, pp. 62-66, 1979, which is incorporated herein by reference in its entirety.

At step 325, alternatively an entropy based approach for image thresholding can be used as described in publications titled “A new method for gray-level picture thresholding using the entropy of the histogram” by J. N. Kapur, P. K. Sahoo, and A. K C. Wong, published in J. Comput. Vision Graphics Image Process., vol. 29, pp. 273-285, 1985 and “Picture thresholding using an iterative selection method”, by T. Ridler and S. Calvard, published in IEEE Trans. Systems Man, Cyber., vol. 8, pp. 630-632, 1978, which are incorporated herein by reference in its entirety.

At step 330, boundary of the epithelial region is extracted using morphological boundary extraction technique as described in a book titled “Digital Image Processing” by R. C. Gonzalez and R. E. Woods, second edition, pp. 556-557, which is incorporated herein by reference in its entirety.

At step 335, non-epithelial region pixels detected in the step 330 are removed using connected component labeling technique and the boundary of the epithelial region is extracted as described in “Digital Image Processing” by R. C. Gonzalez and R. E. Woods, second edition, pp. 558-561, which is incorporated herein by reference in its entirety.

At step 340, basal cell nuclei in the epithelial region are extracted. Extracting the basal cell nuclei in the epithelial region is based on a parabola curve fitting technique, a watershed segmentation technique, thresholding, and a connected component labeling technique. The techniques for extracting the basal cell nuclei are described in a publication titled “Fitting nature's basic functions part i: polynomials and linear least squares” Rust, B. W, computing in science and engineering, 84-89, 2001” and Digital Image Processing” by R. C. Gonzalez and R. E. Woods, second edition, pp. 644-646, which is incorporated herein by reference in its entirety.

At step 345, one or more parameters of the epithelial region as well as parameters of the basal cell nuclei are determined to detect oral sample as pre-malignant or non-malignant. The parameters include thickness of epithelial region, visual texture of the epithelial region, number of basal cell nuclei per unit length, size of the basal cell nuclei, and shape of the basal cell nuclei.

In one embodiment, the thickness of the epithelial region is based on length of epithelium contour. Generally, the epithelial region is not a closed contour and the length of the epithelium contour is always higher than other unwanted edges. Further, techniques including edge linking and connected component labeling technique are used to extract the contours of the epithelium. Further, euclidean distance of the epithelial region is determined after hotelling transform as described in “Digital Image Processing” by R. C. Gonzalez and R. E. Woods, second edition, pp. 700-701, which is incorporated herein by reference in its entirety. The hotelling transform is performed to rotate the epithelium contour to make it horizontal. Further, mean distance, median distance, maximum distance, minimum distance, and standard deviation can be computed to determine thickness of the epithelial region.

The visual texture of the epithelial region is based on variations in gray-scale intensities of the pixels in the gray-scale image. The visual texture is determined based on fractal dimension of the epithelial region. To measure variation in the grayscale image the technique described in “Fractal dimension estimation for texture images: A parallel approach” Biswas, M., Ghose, T., Guha, S., & Biswas, P. Pattern Recognition letters, vol. 19, pp. 309-313, 1998, is incorporated herein by reference in its entirety.

The number of basal cell nuclei per unit length is calculated by performing a parabola curve fitting technique. The parabola curve fitting technique is done with the extracted contour of epithelio-mesenchymal junction for defining the basal layer boundary. The epithelio-mesenchymal junction can be defined as a region where connective tissue of lamina propria meets overlying oral epithelium. The lamina propria is a constituent of the oral mucosa. The color image is super-imposed between the parabola curve and the extracted contour to separate the basal layer. The separated basal layer image is converted into the gray scale image. Further, local variation within cells is diminished after applying an averaging filter. Furthermore, thresholding is performed followed by morphological closing operation with a disk of diameter, for example, 6 pixels. Further the watershed segmentation technique as described in “Digital Image Processing” by R. C. Gonzalez and R. E. Woods, second edition, pp. 644-646, Pearson-Prentice Hall, India”, incorporated herein by reference in its entirety, is used to separate the individual nuclei. Further, the nuclei are labeled based on the connected component labeling technique. The number of nucleus present in the basal layer can be determined based on the labeling. The length of the lower contour of the epithelium is used for counting the number of pixels in that contour and is multiplied with a conversion factor of microscope, for example 0.06 μm to find the length of epithelial contour. The number of cells present in the contour will give the no of cell per unit length.

The size of the basal cell nuclei is based on area of the basal cell nuclei. The area of the basal cell nuclei is measured by counting the number of pixels on interior boundary of the basal cell nuclei and adding one half of the pixels on the perimeter, to correct for the error caused by digitization as described in “Cancer diagnosis via linear programming” Mangasarian and W. H. Wolberg, SIAM News, vol. 23, no. 5, September 1990, pp 1-18, which is incorporated herein by reference in its entirety.

The shape of the basal cell nuclei is based on at least one of the area of basal cell nuclei, perimeter of the basal cell nuclei, compactness of the basal cell nuclei and eccentricity of the basal cell nuclei. The area of the basal cell nuclei is measured by counting the number of pixels on the interior boundary of the basal cell nuclei and adding one half of the pixels on the perimeter, to correct for the error caused by digitization. The perimeter is measured as the sum of the distances between consecutive boundary points. The compactness is measured based on the perimeter and area to give a measure of the compactness of the cell nuclei and is calculated as shown in equation 1 given below:

$$compactness = \frac{{perimeter}^{2}}{area} \qquad ( equation 1 )$$

Eccentricity is the ratio of the length of minor (u) to major (v) axis of the ellipse approximation of the basal cell nuclei and is calculated as shown in equation 2 given below:

$$Eccentricity = \frac{u}{v} \qquad ( equation 2 )$$

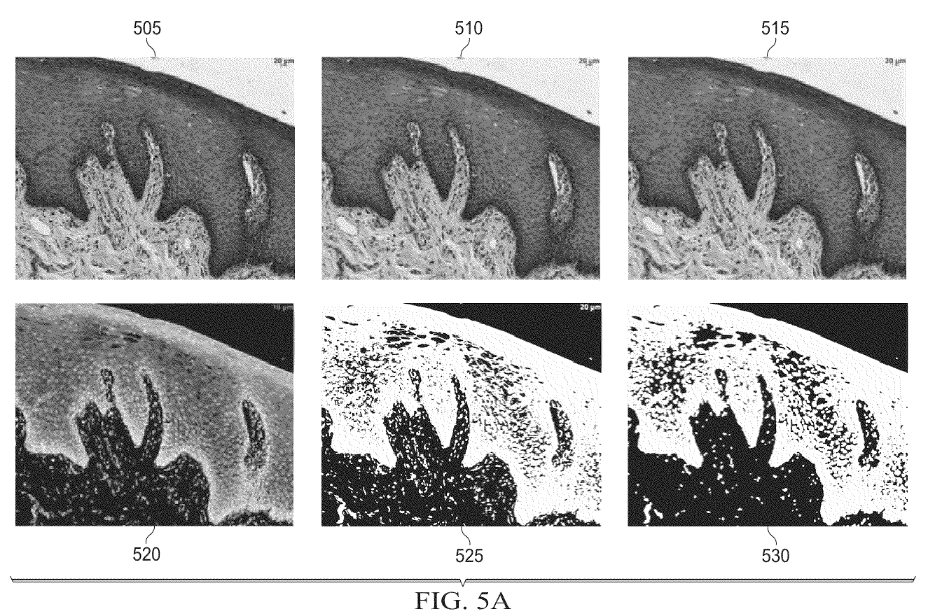

FIG. 4 is a flow diagram illustrating another method for analyzing an image of an oral sample.

At step 405, an image of the oral sample is received.

At step 410, the image is converted to a gray-scale image.

At step 415, at least one of thickness of the epithelial region, visual texture of the epithelial region, number of basal cell nuclei per unit length, size of the basal cell nuclei, and shape of the basal cell nuclei from the image is detected.

At step 420, the oral sample is classified as pre-malignant or non-malignant based on the detection.

The parameters enable detection of the oral sample as one of pre-malignant and non-malignant. Pre-malignant can be defined as pre-cancerous. Non-malignant can be defined as being non-cancerous, for example being benign. In some embodiments, a subset of the parameters can be used for detection based on accuracy desired. Reduction in number of parameters being processed helps in reducing computational power of the IPU.

In some embodiments, the oral sample can be classified as one of pre-malignant and non-malignant based on at least one of the perimeter, the area, the compactness, the eccentricity of the basal cell nuclei and the texture of the epithelial region. The classification can be done by comparing the parameters with a predefined set of values for different grades of cancers. For example, cancers can be differentiated based on degrees. The predefined set of values can be different for different grades of cancers. A cancer can be detected when the parameters satisfy the predefined set of values. Each predefined value can be a number or a range.

Various techniques can be used for classification, for example a Bayesian classifier technique as described in “Pattern Classification”, Duda R. 0., Hart P. E., and Stork D. G, pp. 20-23, Wiley, 2005, can be used and is incorporated herein by reference in its entirety.

In some embodiments, an abnormalities marked image can be generated based on the parameters.

In some embodiments, at least one of transmitting the abnormalities marked image, storing the abnormalities marked image, and displaying the abnormalities marked image can be performed. The abnormalities marked image can then be used by doctors and experts.

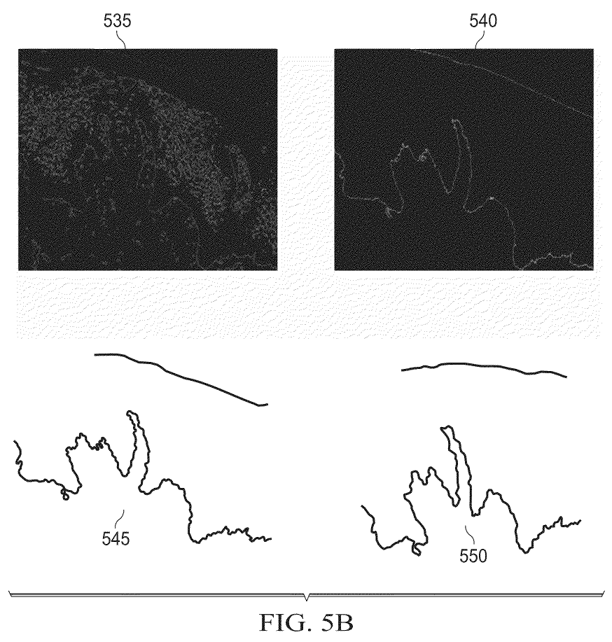

FIG. 5 illustrates images corresponding to each step in computing thickness of epithelial region. An image 505 of an oral sample is received by IPU. The image 505 is converted to a gray-scale image 510. The gray-scale image 510 is de-noised to remove speckle noise and salt-pepper noise using a weighted median filter to render an image 515. The image 515 is subjected to histogram stretching to render an image 520. The image 520 is converted to a binary image 525 based on Otsu auto-thresholding technique. Morphological operations are performed on image 525 to render an image 530. Further, the boundaries of epithelial region are detected using morphological boundary extraction technique to render an image 535. The boundaries of epithelial region then are extracted using connected component labeling technique to render an image 540. The extracted boundaries are depicted in image 545. The boundaries are further rotated to make the boundaries horizontal as depicted in image 550.

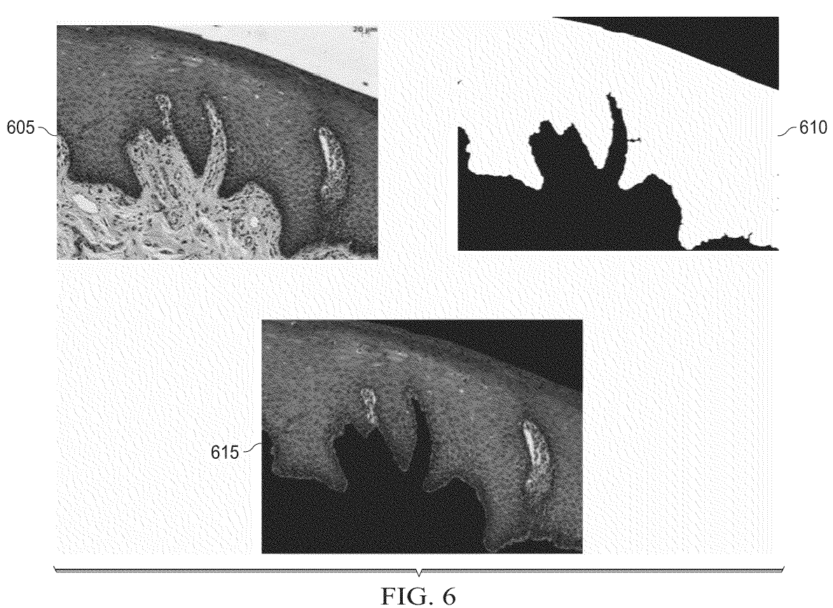

FIG. 6 illustrates images corresponding to each step in computing texture of epithelial region. An image 605 of oral sample is processed to render an image 610 that illustrates mask of epithelial region obtained from the image 605. The epithelium region is extracted to render an image 615.

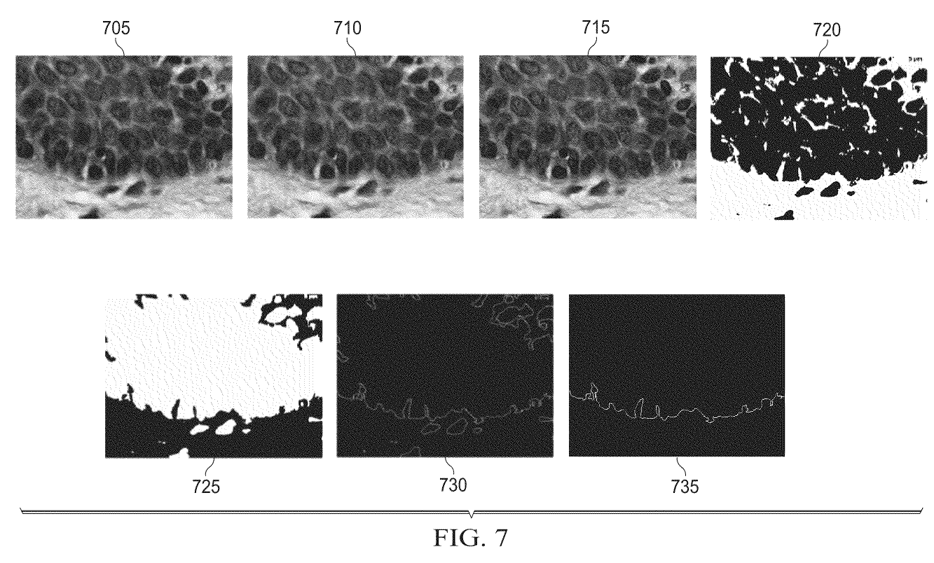

FIG. 7 illustrates images corresponding to each step in extracting basal layer of epithelial region. An image 705 is converted to a gray-scale image 710. The gray-scale image is de-noised to render an image 715. The image 715 is converted to a binary image 720 based on Otsu auto-thresholding technique. Morphological operations are performed on the image 720 to render an image 725. Further, the boundaries of the epithelial region are detected using morphological boundary extraction technique to render an image 730. Furthermore, the boundaries of the epithelial region are extracted using connected component labeling technique to render an image 735. The image 735 represents epithelio-mesenchymal junction.

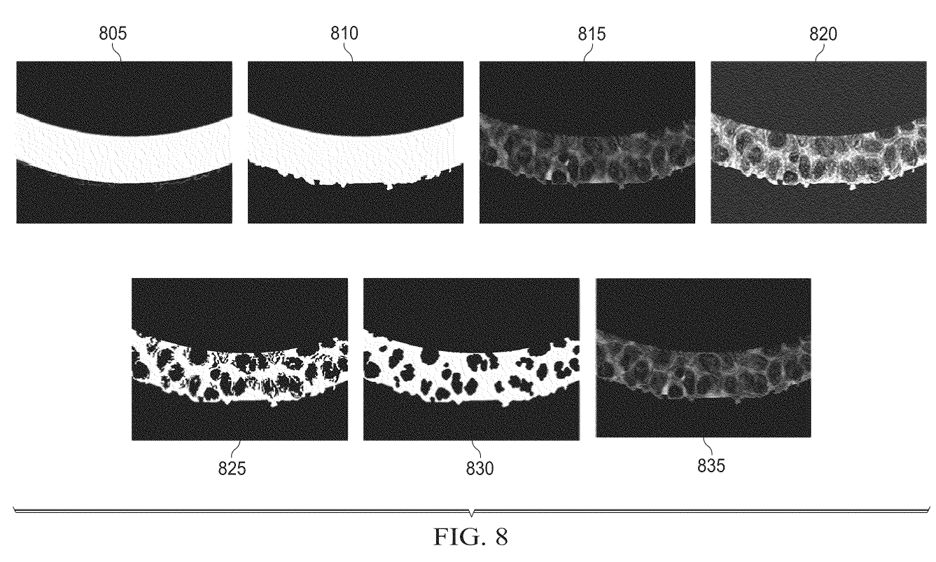

FIG. 8 illustrates images corresponding to each step in computing number of basal cell nuclei per unit length. A parabola fitting technique that generates parallel parabolas are applied on an image of an oral sample to render an image 805. A hole filling technique is performed on the image 805 to render an image 810. An extracted basal layer is shown in image 815. Color deconvolution as described in “Quantification of histochemical staining by color” deconvolution, Ruifrok, A. C., & Johnston, D. A. (2001). Anal Quant Cytol Histol, 291-299, incorporated herein by reference in its entirety, is performed on image 815 to render an image 820. The image 820 is converted to an image 825 based on Otsu auto-thresholding technique. Morphological operations, for example erosion, are used to render an image 830 that illustrates the image having nucleus. Watershed segmentation algorithm is used to render an image 835.

An example of the thickness values for non-malignant and the OSF affected epithelial region is illustrated in Table 1.

TABLE 1

| | Non-malignant | OSF |
|---|---|---|
| Mean | 391.46 μm | 122.52 μm |
| Median | 389.36 μm | 121.83 μm |
| Standard deviation | 75.37 μm | 8.5 μm |
| Minimum | 172.07 μm | 106.76 μm |
| Maximum | 502.40 μm | 159.51 μm |

An example of the fractal dimension values for non-malignant and the OSF affected epithelial region is illustrated in Table 2.

TABLE 2

| | Non-malignant | OSF |
|---|---|---|
| Fractal Dimension | 2.2515 | 2.0768 |

An example of the number of basal cell nuclei per unit length values for non-malignant and the OSF affected epithelial region is illustrated in Table 3.

TABLE 3

| Non-malignant | OSF |
|---|---|
| 11 | 16 |

A plurality of parameters, for example area, perimeter, compactness, and eccentricity of the cell nucleus is determined. An example of the values of the parameters is illustrated in Table 4.

TABLE 4

| | Non-malignant | | OSF | |
|---|---|---|---|---|
| Nuclei Features | Mean ± SD | | Mean ± SD | |
| Area | 7.8402 ± 1.9209 | (μm)² | 14.1241 ± 2.4664 | (μm)² |
| Perimeter | 9.3487 ± 1.3238 | μm | 13.0079 ± 1.5219 | μm |

| | | |
|---|---|---|
| Compactness | 11.3439 ± 1.0782 | 12.1012 ± 1.6833 |
| Eccentricity | 0.8904 ± 0.1253 | 0.8810 ± 0.1375 |

In the foregoing discussion, the term “coupled or connected” refers to either a direct electrical connection or mechanical connection between the devices connected or an indirect connection through intermediary devices.

The foregoing description sets forth numerous specific details to convey a thorough understanding of embodiments of the disclosure. However, it will be apparent to one skilled in the art that embodiments of the disclosure may be practiced without these specific details. Some well-known features are not described in detail in order to avoid obscuring the disclosure. Other variations and embodiments are possible in light of above teachings, and it is thus intended that the scope of disclosure not be limited by this Detailed Description, but only by the Claims.

What is claimed is:

1. A method for analyzing an image of an oral sample, the method comprising:
receiving the image of the oral sample;
converting the image to a gray-scale image;
de-noising the gray-scale image;
enhancing epithelial region in the gray-scale image;
generating a binary image from the gray-scale image;
detecting boundary of the epithelial region in the binary image;
extracting the boundary of the epithelial region;
extracting basal cell nuclei in the epithelial region; and
determining one or more parameters of the epithelial region and the basal cell nuclei to enable detection of the oral sample as one of pre-malignant and non-malignant.

2. The method as claimed in claim 1, wherein analyzing of the image is performed by an image processing unit (IPU), the IPU being electronically coupled to a source of the image.

3. The method as claimed in claim 2, wherein the source comprises
a digital camera.

4. The method as claimed in claim 1, wherein the oral sample comprises
a haematoxylin and eosin stained sample.

5. The method as claimed in claim 1, wherein de-noising the gray-scale image comprises
removing at least one of a speckle noise and a salt-pepper noise using a weighted median filter.

6. The method as claimed in claim 1, wherein enhancing the epithelial region comprises
enhancing the epithelial region based on a histogram stretching technique.

7. The method as claimed in claim 1, wherein generating the binary image comprises
generating the binary image based on Otsu auto-thresholding technique.

8. The method as claimed in claim 1, wherein detecting the boundary comprises
detecting the boundary of the epithelial region based on morphological boundary extraction technique.

9. The method as claimed in claim 1, wherein extracting the boundary comprises
removing pixels of non-epithelial region based on connected component labeling technique.

10. The method as claimed in claim 1, wherein extracting the basal cell nuclei comprises
extracting the basal cell nuclei based on a parabola curve fitting technique, a watershed segmentation technique, thresholding, and a connected component labeling technique.

11. The method as claimed in claim 1, wherein determining the one or more parameters comprises determining at least one of:
thickness of the epithelial region based on at least one of mean distance, median distance, maximum distance, minimum distance, and standard deviation;
visual texture of the epithelial region based on variations in gray-scale intensities of pixels in the gray-scale image;
number of basal cell nuclei per unit length;
size of the basal cell nuclei based on area of the basal cell nuclei; and
shape of the basal cell nuclei based on at least one of area of the basal cell nuclei, perimeter of the basal cell nuclei, compactness of the basal cell nuclei and eccentricity of the basal cell nuclei.

12. The method as claimed in claim 1 and further comprising:
extracting fractal dimension of the epithelial region in the gray-scale image.

13. The method as claimed in claim 1 and further comprising:
generating an abnormalities marked image based on the one or more parameters; and
performing at least one of
transmitting the abnormalities marked image;
storing the abnormalities marked image; and
displaying the abnormalities marked image.

14. A method for analyzing an image of an oral sample by an image processing unit, the method comprising:
receiving the image of the oral sample;
converting the image to a gray-scale image;
detecting at least one of thickness of epithelial region, visual texture of the epithelial region, number of basal cell nuclei per unit length, size of the basal cell nuclei, and shape of the basal cell nuclei from the gray-scale image; and
classifying the oral sample as one of pre-malignant and non-malignant based on the detection.

15. An image processing unit for analyzing an image of an oral sample, the image processing unit comprising:
an image and video acquisition module that electronically receives the image; and
a digital signal processor that detects at least one of thickness of epithelial region, visual texture of the epithelial region, number of basal cell nuclei per unit length, size of the basal cell nuclei, and shape of the basal cell nuclei from the image to enable detection of the oral sample as one of pre-malignant and non-malignant.

16. The image processing unit as claimed in claim 15, wherein the image processing unit is coupled to an image sensor.

17. The image processing unit as claimed in claim 16, wherein the image sensor is coupled to a microscope using an opto-mechanical coupler.

18. The image processing unit as claimed in claim 16, wherein the image sensor comprises
a digital camera.

19. The image processing unit as claimed in claim 15, wherein the image processing unit is coupled to at least one of:
a display; and
a storage device.

20. The image processing unit as claimed in claim 15, wherein the image processing unit is coupled to
a network to enable reception and transmission.
